(19) United States
(12) Patent Application Publication
(10) Pub. No.: US 2008/0196920 A1
(43) Pub. Date: Aug. 21, 2008

(54) Expansion Vessel for Stepping Switches

(75) Inventor: Jorg Findeisen, Dresden (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 11/995,771

(22) PCT Filed: Jul. 14, 2006
(86) PCT No.: PCT/EP2006/064292

§ 371 Date: Jan. 15, 2008

(30) Foreign Application Priority Data
Jul. 15, 2005 (DE) 10 2005 033 925.5
Jul. 17, 2005 (DE) 10 2005 034 851.3

(51) Int. Cl. H05K 5/06

(52) U.S. Cl. 174/50.5

(57) ABSTRACT

A stepping switch S has a housing filled with a dielectric liquid and devices for compensating for thermally related volume variations of the liquid. A bellows/compensator switch K is used to take up the volume variation of the dielectric liquid. The compensation device forms a compact structural component devoid of an additional conduit and mounted directly on the switch. The inventive expansion tank configuration makes it possible to integrate pressure-relieving devices and to place the monitoring units of the stepping switch in a space-saving manner.

The invention relates to a stepping switch which is filled with an insulating liquid, and to devices for absorbing the thermally dependent volume fluctuations of this insulating liquid.

The invention allows the switch vessel to be hermetically sealed and thus allows the aging of the switch oil to be considerably reduced.

The use of the arrangement according to the invention also makes it possible to dispense with air dehumidifiers, an external expansion vessel and associated pipelines. Furthermore, the invention solves the problem of gas collection in the pipeline to the expansion vessel of hermetically sealed switches.

Stepping switches of the type mentioned above are used predominantly in power transformers in order to regulate the on-load voltage. During operation, considerable temperature fluctuations occur as a result of heating of the transition resistances, heat emission from the transformer insulating and cooling medium which surrounds the switch and its vessel, and further influences. These result in significant changes in the volume of the insulating liquid in the stepping switch. Furthermore, switching arcs and/or heating of the transition resistances lead/leads to thermal breakdown of the insulating liquid, and to gas being developed as a result of this. These gases rise upwards because of their lower density, and must be dissipated by means of suitable measures.

The prior art is the use of expansion vessels which are fitted above the transformer and are connected to the switch via an inclined pipeline. This pipeline is used not only for the insulating liquid to flow through in the event of thermally dependent volume changes, but also to transport the gases away.

It is known for a common expansion vessel to be used for the transformer and for the switch, but this results in the insulating liquids being mixed. A two-chamber expansion vessel is therefore predominantly used at the moment. Expansion vessels such as these are described, for example, in DE19527763C2. These expansion vessels have the disadvantage that the oil surface makes contact with the external air, necessitating the use of so-called air dehumidifiers. The air is passed over a desiccant in these air dehumidifiers, and has moisture removed from it in the process. The adsorption capability of the desiccant (hydroscopic capacity) is consumed during this process and the desiccant must be replaced regularly. The periodically required visual checks as well as the regular replacement of the desiccant, particularly in circumstances where the air humidity is high, represents a considerable cost factor (recommended servicing interval: 3 months). These air dehumidifiers furthermore do not offer reliable protection against moisture and oxygen being absorbed by the insulating liquid, particularly when the transformer is cooling down rapidly.

DE 10010737 A1 describes a hermetically sealed transformer which provide an expandable radiator for volume equalization. The use of a radiator such as this in order to compensate for the volume expansion of the insulating liquid of the switch requires considerable complexity and results in problems in dissipation of gases from the switch vessel. For expansion of the insulating liquid from transformers, expansion vessels are known which use a membrane in the main chamber in order to separate the insulating liquid from the environmental air. One such is described in DE 3206368. Although these expansion vessels offer reliable separation of the insulating liquid from the environmental air, they nevertheless require an air dehumidifier, however, and this is associated with the disadvantages that have already been mentioned. Furthermore, the contact with the environmental air leads to aging of the membrane, and to technical uncertainties resulting from this. DE 10224074 A1 describes an arrangement for the pipeline leading into the stepping switch, which uses a labyrinth system in order to avoid the flow of gases to the expansion vessel. However, this system offers neither hermetic sealing of the switch nor can it completely prevent gases entering the pipeline. In addition, the complex pipeline arrangement to the oil expansion vessel is still required.

DE 3504916 C2 also discloses an expansion vessel which is mounted directly on the stepping switch head. This solution likewise requires an air dehumidifier, resulting in the known disadvantages, which have already been mentioned above. In addition, hermetic sealing cannot be achieved in this way.

WO 98/54498 describes a covering shroud for pressure relief valves, and DE 10312177 describes the integration of a covering shroud in a pressure relief valve. Both solutions are subject to considerably handling problems and require a large amount of space.

The invention described in the following text makes it possible to compensate for changes in the volume of the insulating liquid during operation of the switch, while avoiding the disadvantages mentioned above.

The present invention uses a folding bellows/compensator in order to absorb the thermally dependent volume fluctuations of the insulating liquid in the switch. According to the invention, this compensation apparatus forms a compact assembly without additional pipelines, and is mounted directly on the switch. The shape of the expansion vessel is largely matched to the contour of the stepping switch head, thus keeping the space required small. The expansion vessel therefore forms a unit together with the switch, and remains fitted even during transportation. There is no need for tedious assembly of the expansion vessel and pipelines for installation of the transformer. When using folding bellows and/or compensators, only the volume difference between the extended state and the folded-up state can be used for volume equalization processes. The base volume in the folded-up state cannot be used. According to the invention, the unusable volume is restricted to a minimum by the introduction of an insert in the form of a pan or pot. In one particular embodiment of the invention, this pot is designed so as to create a cavity which can be used to hold or accommodate the necessary protection and monitoring means.

In a further particular embodiment of the invention, this pot is designed such that it is used as a covering and protective shroud for the protective, monitoring and control appliances. In a further embodiment of the invention, the pot is in the form of a cover and spray protection for a pressure relief valve. The pot catches and dissipates the hot oil wave in the event of a fault.

This arrangement according to the invention results in the equalizing body becoming a component of the switch. There are no additional external assemblies, thus simplifying the overall transformer. Problems with gas accumulations in pipelines and impediments to the oil flow in the event of temperature changes in the insulating liquid are precluded by the absence of assemblies that result in these problems.

The configuration according to the invention of the volume compensation device allows the insulating liquid in the switch to be completely separated from the atmosphere/environmental air. This prevents moisture and oxygen from being absorbed by the insulating liquid. This avoids the electrical dielectric strength of the insulating liquid from being influenced by moisture, and considerably reduces the aging of the insulating liquid. The external expansion vessel, the air dehumidifier and the associated pipelines may be dispensed with. There is no need to regularly check the state of the desiccant in the air humidifier, and cost savings result from there being no need for costly regular replacement of the desiccant. Environmental contamination and disposal problems resulting from consumed desiccants are avoided.

In one advantageous refinement of the invention, the switch is equipped with a gas outlet valve (V3). This can expediently be designed or controlled such that it responds in the event of a low gas pressure, but not to the presence of insulating liquid. This is advantageously achieved by using a float (SW) to control the gas outlet valve. This allows the gases to be pumped out continuously. A conventional large-area pressure relief valve (D1) may be provided for protection against pressure waves occurring in the event of a fault.

The combination of a pressure relief device which is independent of the filling level and a pressure relief device which is dependent on the filling level but responds even at a slight overpressure allows reliable bursting protection for the switch vessel while gases that are formed are dissipated continuously.

Furthermore, the use of a multiwall bellows makes it possible to achieve complete bursting safety, while this embodiment also allows leakage monitoring. The use of a guide tube makes it possible to protect the compensator bellows against bulging out (bending) at the side. This guide tube can likewise be used to absorb lateral acceleration forces that occur during transportation of the transformer. The pressure wave guide device for the pressure relief valve is used as a guide tube for the bellows. The pressure wave guide device is designed such that it ensures that the pressure waves are passed on safely both when the compensator is expanded and when the compensator is compressed. The moving basic element of the compensator is the metal bellows which, because of its corrugations which surround it in annular shape, has axial mobility which is used in the expansion vessel according to the invention to compensate for the thermally dependent volume changes of the insulating liquid in the stepping switch. The bellows obtain their mobility from the flexibility of the radial corrugation flanks. Corrugation in the form of a lyre is in this case preferable for the described application, because of the high degree of mobility with adequate pressure resistance.

In a further preferred embodiment, the equalizing body is provided with a spring element in order to achieve a predetermined pressure tolerance range. These spring elements may also be formed by the body of the compensator itself.

In one specific embodiment, the compensation apparatus is equipped with a volume limiting means in one or else both directions. By way of example, this makes it possible to provide a pressure tolerance range appropriate for special requirements in the switch vessel. This limiting is likewise possible by limiting the linear movement of the compensating element and by means of a multipart compensation apparatus with chambers with a different spring constant.

The invention will be described in more detail in the following text with reference to exemplary embodiments.

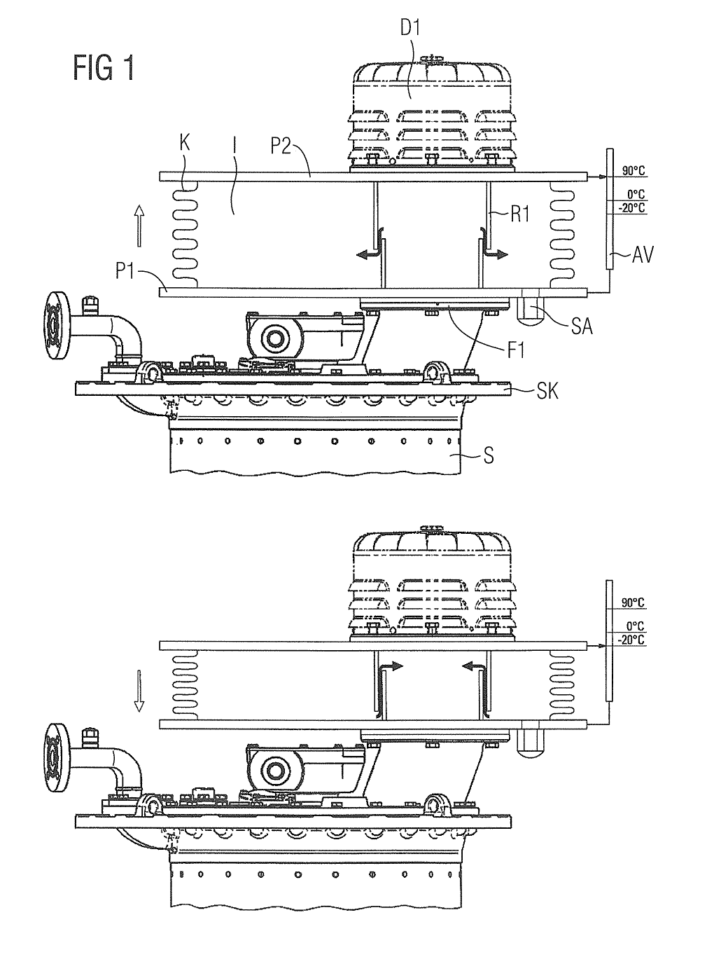

FIG. 1 shows a switch (S) with a switch head (SK) which is arranged on the cover (TD) of a transformer. The space inside the switch (S) is filled with the insulating liquid. Since the housing of the switch (S) seals it hermetically, the internal pressure in the switch increases when the insulating liquid in the switch is heated. This pressure increase results in expansion of the compensator (K). Gases formed by thermal breakdown of the oil rise upwards, and are passed through the cylindrical pipe pieces (R1) to a monitoring device (D1) One of the two pipe segments (R1) is arranged on the moving endplate of the compensator. These pipe pieces are designed in such a way that they ensure reliable dissipation of pressure waves to the pressure relief valve (D1) in every compensator position. The height is in this case designed such that the compensator exploits it full mobility, ensuring a reliable oil flow between the switch and the expansion vessel. The cross section of the pressure wave channel formed by the pipe piece (R1) to the pressure relief valve (D1) is in this case of such a size that pressure waves are passed to the pressure relief valve without any impediment. The oil channel into the expansion vessel is formed in the exemplary embodiment by the intermediate space between the two pipe or guide pieces (R1+R2), is designed in such a way that it allows, for the slow thermally dependent volume fluctuations, a suitable oil flow that has adequate damping for explosive increases in volume in the event of damage to ensure that the pressure wave is not transmitted to the bellows but is passed within the pipe connecting stub (R1) to the pressure relief valve (D1).

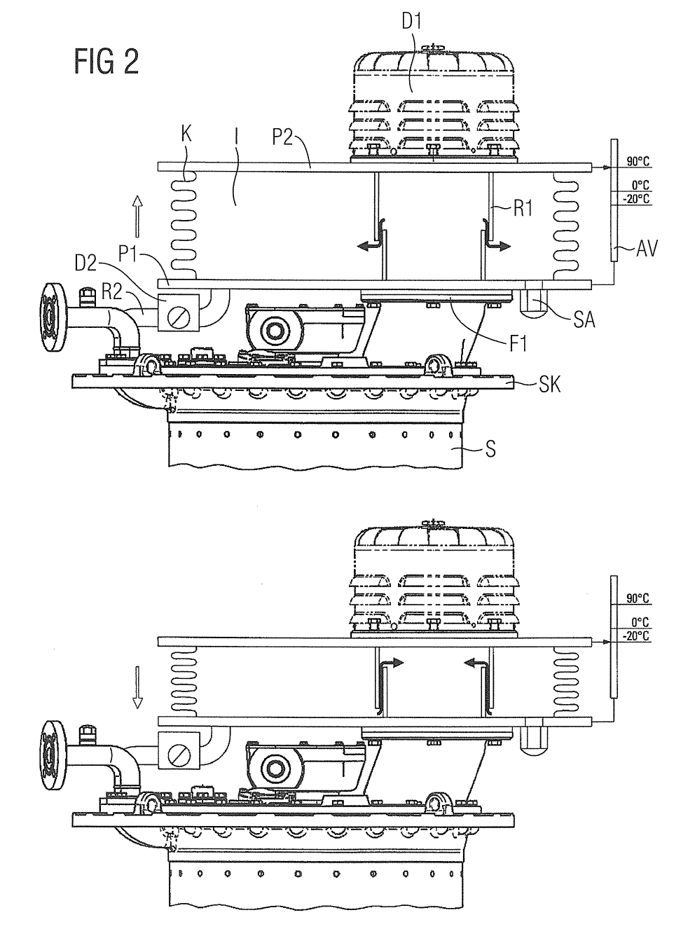

FIG. 2 shows a stepping switch (S) according to the invention with an expansion vessel, with a protective relay (D2), as is normally used for stepping switches, being connected to the interior of the switch (S) via the pipeline (R2).

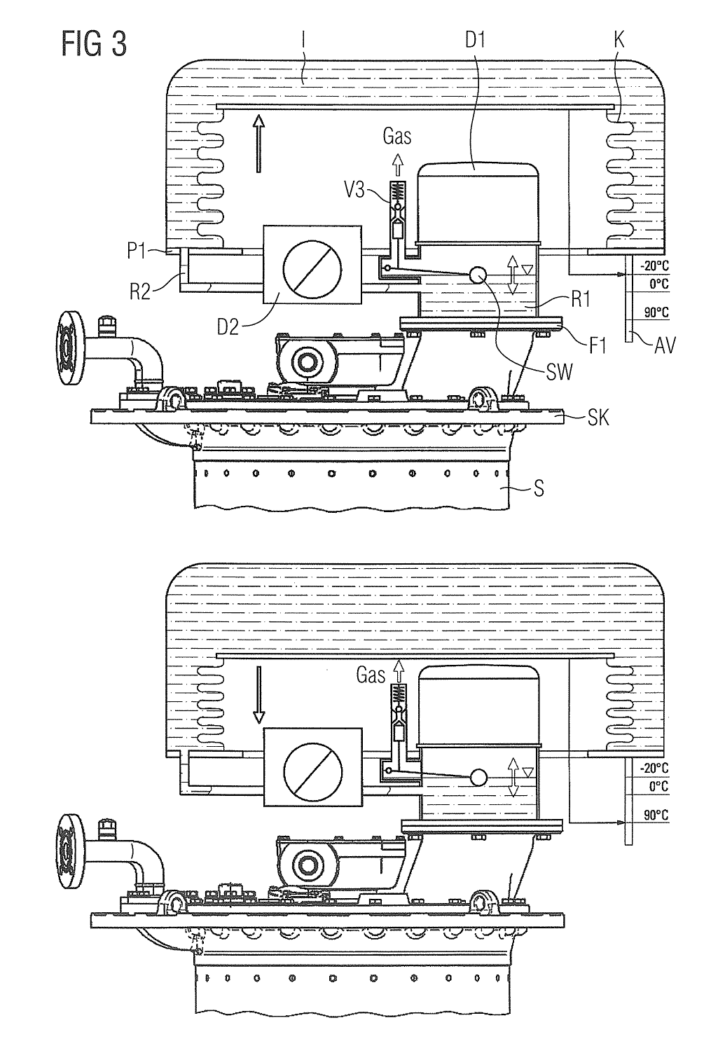

FIG. 3 shows one exemplary embodiment of the switch expansion vessel in which a bellows (K) is installed as a negative compensator in the cylindrical expansion vessel. The axial movement of the bellows leads to volume matching. During this process, the moving inner cover plate of the expansion vessel (P2) and the bellows (K) form a cavity which is used to accommodate the monitoring appliances for the switch. The movement of the cover plate (P2) is used to indicate the oil volume on an indicating apparatus (AV), or the temperature corresponding to this, of the insulating liquid in the stepping switch.

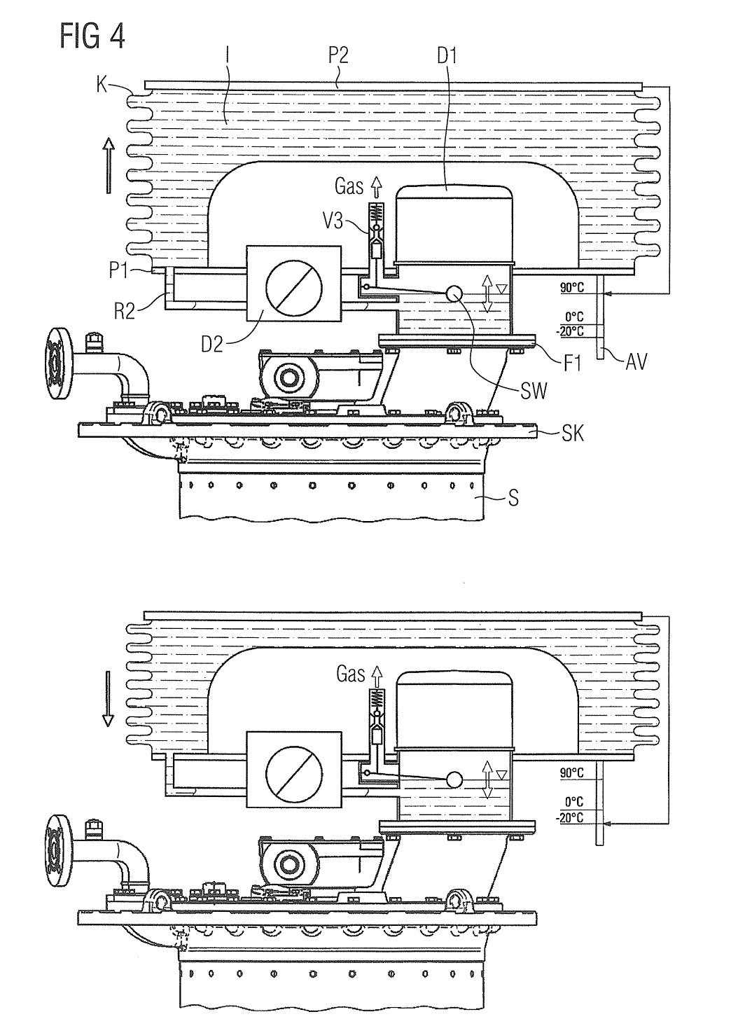

FIG. 4 shows one exemplary embodiment of the switch expansion vessel in which a bellows (K) acts as a positive compensator to compensate for volume fluctuations of the insulating liquid in the stepping switch. The expansion vessel, which is formed by the bellows, contains a stationary inner cylinder (T) in the form of a pot, which surrounds the monitoring appliances for the stepping switch. This inner cylinder (T) in the form of a pot is advantageously largely matched to the shape of the bellows (K) in the compressed state. In the exemplary embodiment, this inner cylinder is at the same time used as an oil trapping shroud and as spray protection for a pressure relief valve (Dl) which is surrounded by this cylinder.

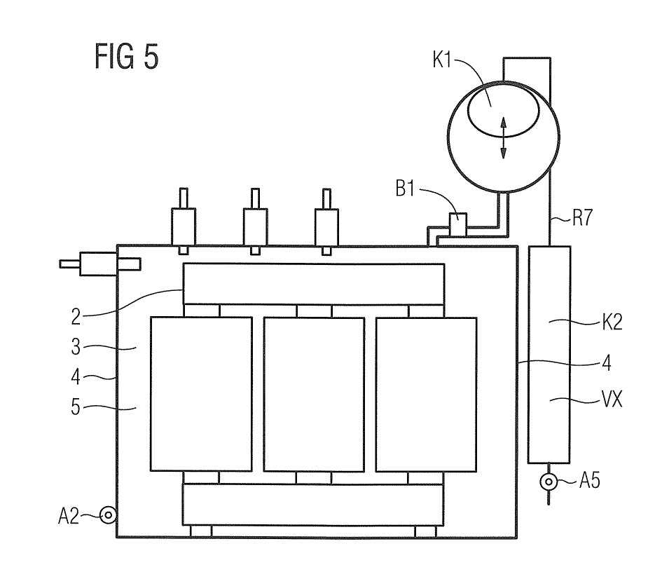

FIG. 5 shows a transformer as an electrical component with a hermetically sealed housing (4) which is filled with an insulating liquid (5). Via a pipeline, which is connected to a Buchholz relay (B1) and an expansion vessel (K1). A membrane is accommodated in the expansion vessel (K1) and separates the insulating liquid from the gas. The gas area is equipped, via a pipeline (R7) with further chambers for a second gas cushion (K2), which is arranged such that the gas cushion (K2) is thermally decoupled from the temperature of the insulating liquid (5) in the transformer.

1-19. (canceled)

20. An electrical component, comprising:
a sealed housing;
an insulating liquid in said sealed housing;
a compensation apparatus for absorbing temperature-dependent volume changes of said insulating liquid mounted directly on a head of the electrical component, said compensation apparatus having an expansion vessel with a folding bellows configured to absorb volume fluctuations of said insulating liquid.

21. The electrical component according to claim 20, formed as a stepping switch.

22. An expansion vessel assembly for the electrical component according to claim 20, comprising:
a compensation apparatus having an oil volume matched to a useable compensator volume difference by means of a pot-shaped inner cylinder placed in a compensator forming an outer wall, or by means of a negative inner compensator in a pot-shaped outer cylinder.

23. The assembly according to claim 22, wherein said pot-shaped inner cylinder or said bellows of the expansion vessel defines a cavity housing monitoring appliances and fittings for the electrical component.

24. The assembly according to claim 22, wherein said inner cylinder or said bellows of the expansion vessel surrounds a pressure relief valve.

25. The assembly according to claim 22, wherein said inner cylinder or said bellows of the expansion vessel forms a housing of a pressure relief valve.

26. The assembly according to claim 22, wherein said compensation apparatus includes one or more equalizing bodies with a spring element for achieving a predetermined pressure tolerance range.

27. The assembly according to claim 22, wherein said expansion vessel is formed with a stationary part and a moving part each formed with mutually overlapping guide sleeves.

28. The assembly according to claim 22, wherein said compensation apparatus is a multilayer compensator.

29. The assembly according to claim 28, which comprises a leakage monitoring device connected to a cavity formed between layers of said multi-layer compensator.

30. The assembly according to claim 22, which further comprises detection apparatuses for detecting a filling level of said insulating liquid and/or for detection of a pressure.

31. The assembly according to claim 22, wherein a deformation of a compensating element caused by a volume change is used for evaluation and/or indication of a volume of the insulating liquid.

32. The assembly according to claim 31, wherein the electrical component is a switch and the liquid is a switch oil.

33. The assembly according to claim 32, wherein said switch (S) includes apparatuses (V3) for collecting and for evacuating gases formed inside the switch.

34. The assembly according to claim 32, wherein said apparatuses are controlled as a function of an oil level in said expansion vessel.

35. The assembly according to claim 22, which comprises locking devices disposed to limit a maximum expansion of said compensator.

36. The assembly according to claim 22, which comprises a weighting body having a weight for generating a resetting force of said compensator.

37. The assembly according to claim 36, wherein said weighting body is formed by monitoring appliances and fittings for said switch.

38. The assembly according to claim 22, which comprises a protective shroud covering said folding bellows.

39. The assembly according to claim 22, wherein said electrical component is an electrical device filled with insulating medium that expands on heating.

40. The assembly according to claim 22, wherein a gas cushion is formed within said folding bellows for absorbing the temperature-dependent volume fluctuations of said insulating liquid, and said gas cushion is arranged such that the switch is filled to a top cover with insulating liquid in all operating states, and wherein said gas cushion is separated from said insulating liquid by a membrane, said membrane makes no contact with an ambient atmosphere and is located within the hermetically sealed switch.

41. The assembly according to claim 40, wherein parts of said gas cushion are split into separate containers and are connected by way of tightly sealed connections to the container containing said membrane.
